(19) United States
(12) Patent Application Publication
(10) Pub. No.: US 2009/0248902 A1
(43) Pub. Date: Oct. 1, 2009

(54) Command Line Completion Using Invoked Command

(75) Inventor: George M. Blue, Southampton (GB)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/058,468

(22) Filed: Mar. 28, 2008

(51) Int. Cl. G06F 13/14

(52) U.S. Cl. 710/5

(57) ABSTRACT

A method for command line completion comprises receiving a command line completion request from a user comprising a command, a flag and a partial input, executing the command using the flag and passing the partial input to the command, receiving an output from the command comprising valid completions of the partial input or an indication that no valid completions correspond to the partial input, and presenting to the user the valid completions or an indication that no valid completions correspond to the partial input.

### BACKGROUND OF THE INVENTION

1. Field of the Invention

This invention relates to command line completion in a command line interface using an invoked command.

2. Description of Background

Command line interpreters commonly include command line completion, which is a process where partially typed tokens are automatically filled in. These tokens can include various entities such as commands, arguments, file names, and directory names depending on the interpreter and configuration.

As shown in FIG. 1, in a conventional method a user enters 10 a command, a partial input and a request for completion. The shell queries 11 stored responses for a given command. Finally, the shell displays 12 a retrieved selection of stored responses applicable to that command requiring completion. For example, a popular shell Bash allows for the completion of at least user names, shell variables and host names. The command line completion in the Bash shell is intelligent enough to perform some customized command line completion, e.g., providing directory names after the “cd” command.

One very desirable feature of command line completion is the ability for the system to present a list of options to the user when the user invokes completion but the user's entry is ambiguous. While the conventional methods provide for many options and customization of the command line completion, they are not truly generic. For example, if a command line has an option which is a directory name and not a file name, the shell will not know the difference unless it has been programmed for that specific case. In the prior art systems, therefore, the command line completion cannot present an accurate and full list of possible completion options to the user as a general rule.

### SUMMARY OF THE INVENTION

The shortcomings of the prior art are overcome and additional advantages are provided through the use of a method for command line completion by receiving a command line completion request from a user comprising a command, a flag and a partial input, executing the command using the flag and passing the partial input to the command, receiving an output from the command comprising valid completions of the partial input or an indication that no valid completions correspond to the partial input and presenting to the user the valid completions or an indication that no valid completions correspond to the partial input

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, command line completion methods are enhanced thereby simplifying command entry for users, which results in savings in time and costs associated with command entry by providing users with command specific completion options unavailable in the prior art.

### BRIEF DESCRIPTION OF THE DRAWINGS

The subject matter which is regarded as the invention is particularly pointed out and distinctly claimed in the claim at the conclusion of the specification. The foregoing and other objects, features, and advantages of the invention are apparent from the following detailed description taken in conjunction with the accompanying drawings in which:

FIG. 1 shows a conventional method of command line completion;

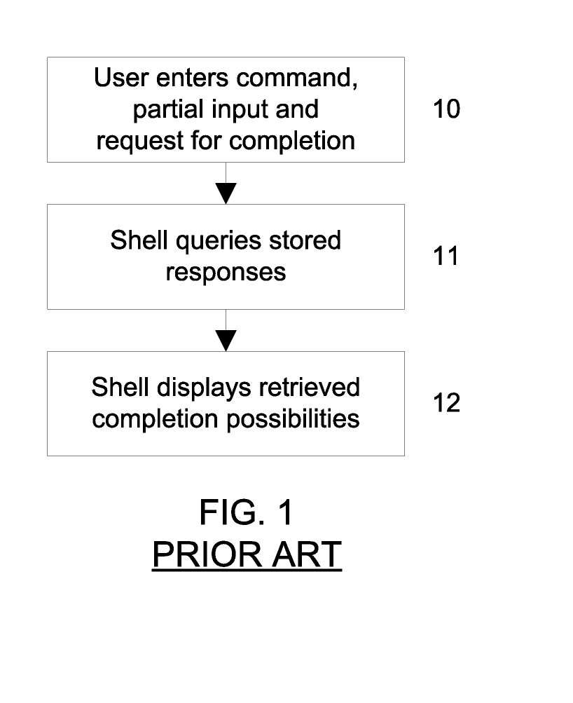

FIG. 2 shows an illustrative example in accordance with the invention;

FIG. 3 shows a flow chart illustrating a method of command line completion according to a preferred embodiment of the invention.

The detailed description explains the preferred embodiments of the invention, together with advantages and features, by way of example with reference to the drawings.

### DETAILED DESCRIPTION OF THE INVENTION

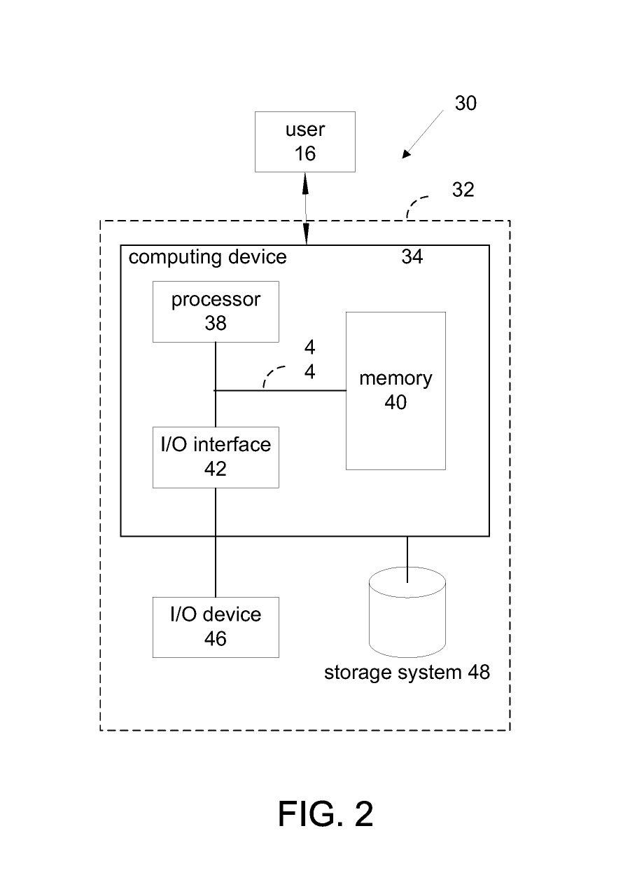

The invention herein involves command line completion in a command line interface using an invoked command to return command-specific completion options. With reference to the accompanying drawings, FIG. 2 shows an illustrative environment 30 for managing the processes in accordance with the invention. To this extent, the environment 30 includes a computer infrastructure 32 that can perform the processes described herein. In particular, the computer infrastructure 32 is shown including a computing device 34 operable to perform the processes described herein.

The computing device 34 is shown including a processor 38, a memory 40, an input/output (I/O) interface 42, and a bus 44. Further, the computing device 34 is shown in communication with an external I/O device/resource 46 and a storage system 48. As is known in the art, in general, the processor 38 executes computer program code, which is stored in memory 40 and/or storage system 48. While executing computer program code, the processor 38 can read and/or write data, such as the range boundary 50, to/from memory 40, storage system 48, and/or I/O interface 42. The bus 44 provides a communications link between each of the components in the computing device 34. The I/O device 46 can comprise any device that enables an individual to interact with the computing device 34 or any device that enables the computing device 34 to communicate with one or more other computing devices using any type of communications link.

The computing device 34 can comprise any general purpose computing article of manufacture capable of executing computer program code installed thereon (e.g., a personal computer, server, handheld device, etc.). However, it is understood that the computing device 34 is only representative of various possible equivalent computing devices that may perform the processes described herein. Similarly, the computer infrastructure 32 is only illustrative of various types of computer infrastructures for implementing the invention. For example, in one embodiment, the computer infrastructure 32 comprises two or more computing devices (e.g., a server cluster) that communicate over any type of communications link, such as a network, a shared memory, or the like, to perform the process described herein.

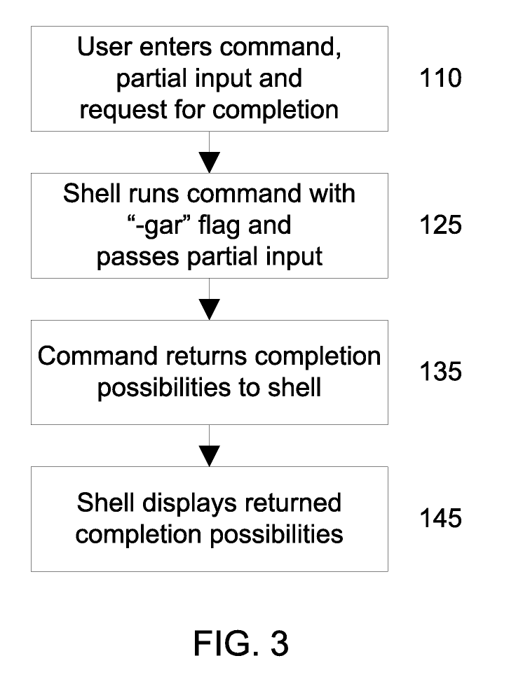

FIG. 3 depicts a flow chart illustrating the process according to the preferred embodiment of the invention, which is implemented by adding a new flag, e.g., “-gar,” to all programs. The name of the flag is unimportant, so long as it is not already in use by any programs. When the shell is asked 110 for command line completion, it runs 125 the name of the command, followed by the -gar flag, and then followed by an the partial input the user has typed on the command line.

The -gar flag causes the command to parse the input and return 135 either an error that the partial input is invalid or a list of possible completion values. The shell processes this output from the command and presents 145 an appropriate response to the user.

And example of the process follows. If a user types “$ extractfile-tar archive.tar-file thi<tab>,” the shell recognizes the <tab> as a request for command line completion. The shell responds by invoking the command extractfile with the -gar flag using “-tar archive.tar-file thi” as the partial input.

The command extractfile returns a list of valid options, i.e., files within the “archive.tar” file that begin with “thi.” The command passes this information to the shell using STDOUT. Assuming there is only one file in the archive.tar starting with “thi,” and the file is named “this_file.txt,” the shell responds to the user by completing the command as follows: $ extractfile-tar archive.tar-file this_file.txt.”

The following pseudo code provides further detail regarding implementing the preferred method:
Usage: extract<archive name><file>
   When being asked to complete a command line, the shell will run the program with the command line:

```
  extract -gar-before <parameters before the one we
  are trying to expand> -gar-parm
<parameter that we are trying to expand> -gar-after <parameters
after the one that we are trying to expand>
```

And the program will print out possibilities, which will be captured by the shell and presented to the user. If there is only one possibility, then the shell will use it.

```
void main (args)
{
  if (args contains “-gar-parameter”)
  {
  // We have been called in the mode where we are expected to
provide suitable expansions
  // for a parameter
  if (args {-gar-before} exists)
  {
    // We are trying to expand a filename in the archive,
    // so look in the archive file for files that match the parameter
    // that we are trying to expand.
    matches = find_matches_in_archive (args {-gar-parm} );
    print STDOUT matches; // Tell the shell about the closest matches
  }
  else
  {
    // We are trying to expand the name of the archive file,
    // so look for matching files on the disk
    matches = match_filename (args {-gar-parm} );
    print STDOUT matches; // Tell the shell about the closest matches
  }
  else
  {
  // We have been called in the mode where we are expected to extract
  // a file as user now believes the command line to be complete.
  check_archive_name (args [1] );
  extract_from_archive (args [1], args [2]);
  }
}
```

While the preferred embodiment to the invention has been described, it will be understood that those skilled in the art, both now and in the future, may make various improvements and enhancements which fall within the scope of the claim which follows. These claim should be construed to maintain the proper protection for the invention first described.

1. A method for command line completion:
receiving a command line completion request from a user comprising a command and a partial input;
in response to receiving the command line completion request, executing the command using a flag and passing the partial input to the command;
determining, by the command, if the command comprises valid completions of the partial input in response to executing the command using the flag;
based on the determination, receiving an output from the command comprising the valid completions of the partial input or an indication that no valid completions correspond to the partial input; and
presenting to the user the valid completions or an indication that no valid completions correspond to the partial input.
